(19) United States
(12) Patent Application Publication
(10) Pub. No.: US 2005/0245664 A1
(43) Pub. Date: Nov. 3, 2005

(54) Process for the preparation of silicon-dioxide-containing polymer beads

(75) Inventors: Wolfgang Podszun, Koln (DE); Reinhold Klipper, Koln (DE); Rudolf Wagner, Koln (DE)

Correspondence Address: Norris, McLaughlin & Marcus P.A., 18th Floor, 875 Third Avenue, New York, NY, 10022, US

(73) Assignee: Lanxess Deutschland GmbH, Leverkusen (DE)

(21) Appl. No.: 11/108,962

(22) Filed: Apr. 19, 2005

(30) Foreign Application Priority Data
Apr. 30, 2004 (DE) 1020040217386

(51) Int. Cl. B29C 71/02; C08K 3/34

(52) U.S. Cl. 524/492; 264/236

(57) ABSTRACT

The present invention relates to a process for the preparation of silicon-dioxide-containing polymer beads by producing a mixture of styrene, crosslinker, finely divided surface-modified silicon dioxide, free-radical initiator and, if appropriate, inert agent and curing the resultant mixture in aqueous phase at elevated temperature to give a polymer bead, the silicon-dioxide-containing polymer beads themselves, and also uses thereof.

The present invention relates to a process for the preparation of silicon-dioxide-containing polymer beads based on crosslinked polystyrene.

Polymer beads made of crosslinked polystyrene are used in many ways for producing ion exchangers, catalysts, adsorbers and chromatography resins. The particle size of conventional polymer beads here is in the range 50-500 μm.

In many applications, liquids are passed through column-type filters packed with the polymer beads. It has now been found that the polymer beads used hitherto do not always have the desired mechanical strength, which can lead to a deformation or even fracture of the beads under load. Both the deformation and the breakage cause an unwanted increase in the pressure drop in the filter. This limitation restricts the technical application and brings economic disadvantages.

The mechanical reinforcement of polymer beads made of acrylate polymer with silicon dioxide as filler is disclosed by EP-A 0 084 769. The polymer beads described there are suitable particularly as components of dental materials.

EP-A 0 545 168 describes optically active polymer beads having a content of 2 to 60% by weight of inorganic filler, which polymer beads can be used for the chromatographic resolution of enantiomeric mixtures.

It is an object of the present invention to provide crosslinked polystyrene polymer beads which are filled with silicon dioxide, as starting material for ion-exchangers, catalysts, adsorbers and chromatography resins.

The present invention relates to, and the object is achieved by, a process for the preparation of a silicon-dioxide-containing polymer bead which is characterized in that
I) a mixture of
   a) styrene
   b) crosslinker
   c) finely divided surface-modified silicon dioxide and
   d) free-radical initiator is produced, and
II) the resultant mixture is cured in aqueous phase at elevated temperature to give a polymer bead.

If appropriate, an inert agent can further be added to the mixture I).

Styrene (a) within the meaning of the present invention is in addition to unsubstituted styrene also substituted styrenes, for example vinylnaphthalene, vinyltoluene, ethylstyrene, α-methylstyrene and chlorostyrenes.

Crosslinkers (b) are compounds which contain two or more, preferably two to four, double bonds which can be polymerized by a free-radical mechanism per molecule. Examples which may be mentioned are: divinylbenzene, divinyltoluene, trivinylbenzene, divinylnaphthalene, trivinylnaphthalene, diethylene glycol divinyl ether, 1,7-octadiene, 1,5-hexadiene, diethylene glycol divinyl ether and butanediol divinyl ether.

The content of crosslinker is generally 1 to 50% by weight, preferably 2 to 16% by weight, based on the sum of the components (a) and (b).

Finely divided silicon dioxide (c) within the meaning of the invention is quartz flour and amorphous silicon dioxide, and in addition finely ground glasses and glass ceramics. Particular preference is given to microfine silicon dioxide which is produced by flame hydrolysis and is available, for example, as a commercial product under the name Aerosil® or HDK® (highly dispersed silicic acid).

Silicon dioxide which is particularly highly suitable is silicon dioxide produced by flame hydrolysis having a mean particle size (primary particle size) of 10 to 40 nm and a BET surface area of 20 to 300 m²/g, preferably 40 to 200 m²/g.

The silicon-dioxide-based filler is surface-treated before its use for preparing the inventive beads. Suitable surface treatment compositions are, primarily, the compounds known as adhesion promoters. Those which are particularly highly suitable are silane compounds which are described, for example, in U.S. Pat. No. 3,066,113 or U.S. Pat. No. 3,539,533. According to the invention, not only saturated silane compounds, for example trimethylchlorosilane, hexamethyldisilazane or γ-glycidoxypropyltrimethoxysilane, but also unsaturated silane compounds can be used.

Unsaturated polymerizable silane compounds which may be mentioned by way of example are: vinyltriethoxysilane, vinyltrimethoxysilane, γ-methacryloxypropyltrimethoxysilane, γ-methacryloxypropyl-tris(2-methoxyethoxy)silane and vinyltriacetoxysilane.

The silane compound is to be used in proportions of 1 to 25% by weight, preferably from 5 to 20% by weight, based on the silicon-dioxide-based filler. The surface treatment is generally carried out in an inert solvent, for example in methylene chloride or toluene, but it is also possible, in many cases, for example in the case of aftertreatment with hexamethyldisilazane, to omit a solvent.

The amount of the surface-modified filler is 0.1-70% by weight, preferably 1-50% by weight, particularly preferably 2-30% by weight, based on components a, b and c.

The mixing of surface-modified silicon dioxide and the components (a) and (b) can be performed in conventional agitators. Preferably, high shear forces are to be used here, for example stirring energies of 1 to 10 watt/I. A high-speed agitator or rotor-stator mixer is also highly suitable. An additional treatment with ultrasound, carried out if appropriate, is particularly advantageous.

During the mixing operation or after completion of mixing, preferably under stirring, a vacuum of 0.01 to 500 torr, particularly preferably of 1 to 300 torr, is applied. The vacuum treatment which is to take place for at least some minutes, for example at least 10 minutes, preferably takes place at room temperature, but higher or lower temperatures can also be employed. It is advantageous here if, in the evacuation, a small fraction of the monomers used (0.01 to 5%) is distilled off, since in this manner traces of water can be removed from the monomers and from the silicon dioxide surface. Expediently, the filler-monomer mixture is aerated with inert gas, for example nitrogen.

For the activation, customary monomer-soluble free-radical initiators (d) can be used; those which may be mentioned by way of example are: peroxide and azo compounds, such as dibenzoyl peroxide, dilauroyl peroxide, cyclohexyl percarbonate and azoisobutyronitrile. Mixtures of polymerization initiators having different decomposition temperatures are also highly suitable. The free-radical initiator can be added before or after the evacuation step. To avoid premature initiation of polymerization, however, it is expedient not to add the free-radical initiators until immediately before the dispersion. The free-radical initiators are used in an amount of 0.05-2% by weight, preferably 0.1 to 0.8% by weight, based on the components (a) and (b).

The inert agents (e) to be added, if appropriate, to the mixture I) are water-immiscible organic liquids. Those which may preferably be mentioned are aliphatic or aromatic hydrocarbons and alcohols having up to 20 carbon atoms, such as hexane, heptane, isodecane, benzene, toluene or octanol, halogenated hydrocarbons, such as di-, tri-, tetrachloromethane or 1,2-dichloroethane, esters, such as methyl acetate, butyl acetate or dialkyl carbonates and water-insoluble ketones, such as methylisobutyl ketone or cyclohexanone.

The weight ratio of inert agent to the components (a) and (b) is 0.1:1 to 3:1, preferably 0.5:1 to 2:1.

The activated silicon dioxide-monomer mixture is, in II), first dispersed by means of a water phase. To produce beads as uniform as possible, it is advantageous to charge the water phase and to add the filler-monomer mixture slowly under stirring.

The ratio of monomer phase to water phase is 1:1 to 1:10, preferably 1:1.5 to 1:4.

Preferably, the water phase comprises a dispersant. Suitable dispersants are all water-soluble macromolecular compounds known for this purpose, for example cellulose derivatives, such as methylcellulose, and partially saponified poly(vinyl acetate)s. Copolymers of (meth)acrylic acid and alkyl(meth)acrylates are also highly suitable. Those which may be mentioned by way of example are the alkaline solution of a copolymer of methacrylic acid and methyl methacrylate. The content of dispersant is preferably to be 0.5 to 5% by weight, based on the water phase.

The polymerization is initiated by heating the mixture in aqueous phase to the decomposition temperature of the polymerization initiator. The reaction is to be conducted in such a manner that the monomers do not boil. If an exothermic reaction is initiated, cooling may need to be performed. It is advantageous to carry out the polymerization at elevated pressure, for example at 2 to 6 bar nitrogen pressure.

The polymer bead can be isolated from the polymerized dispersion in a known manner by decanting, filtering, washing and drying.

The present invention, however, also relates to silicon-dioxide-containing polymer beads obtainable by
I) mixing
   a) styrene
   b) crosslinker
   c) finely divided surface-modified silicon dioxide and
   d) free-radical initiator and
II) curing the resultant mixture in aqueous phase at elevated temperature to give a polymer bead. In a preferred embodiment, inert agent can additionally be added to the mixture at I).

The inventive silicon-dioxide-containing polymer beads are outstandingly suitable as starting materials for ion exchangers, chelating resins, chromatography resins, catalysts or adsorber resins. The end products produced therefrom have a decisively improved mechanical strength.

It will be understood that the specification and examples are illustrative but not limitative of the present invention and that other embodiments within the spirit and scope of the invention will suggest themselves to those skilled in the art.

### EXAMPLES

### Example 1

Silanization of Silicon Dioxide

Into an 8 litre stirred kettle are charged
4 litres of acetone
37.5 g of γ-methacryloxypropyltrimethoxysilane
0.5 g of dicyclohexylamine
10 g of distilled water.

With stirring, 462.5 g of silicon dioxide (mean particle size 30 ml, BET surface area 120 m²/g) are added and the mixture is stirred for 2 hours under reflux. The acetone is then distilled off. The residue is dried for 15 hours at 60° C. and then for a further 6 hours at 90° C. Carbon content of the product: 2.2%.

### Example 2

Silanization of Silicon Dioxide

1500 g of silicon dioxide (Aerosil® OX 50 from Degussa) are placed in a stirred kettle and 265 g of hexamethyldisilazane are added slowly dropwise with vigorous stirring. Then, the mixture is stirred under a weak vacuum until ammonia is no longer detectable.
Carbon content: 0.95%

### Example 3

Preparation of a Silicon-Dioxide-Containing Polymer Bead

An aqueous solution of 2.1 g of methylhydroxyethylcellulose, 4.76 g of disodiumhydrogenphosphate and 1850 g of deionized water is charged into a 4 litre flat-flange reactor equipped with gate agitator, cooler, temperature sensor and thermostat and recorder.

In a separate stirred vessel, 926.7 g of styrene and 24.58 g of divinylbenzene (81.4% pure) are mixed. 50 g of silicon dioxide from Example 1 are added in portions to the resultant mixture and are dispersed for 4 min at 24 000 rpm using a rotor-stator mixer. Thereafter, a vacuum of 250 torr is applied for 10 minutes and the mixture is aerated with nitrogen. Then, 5.7 g of dibenzoyl peroxide are added and dissolved in the resultant dispersion within 15 min.

The activated dispersion is introduced through an elongated funnel with stirring at 320 revolutions/min into the prepared 4 litre flat-flange reactor at 55° C., beneath the surface of the aqueous phase. The mixture is then heated to 63° C., a nitrogen stream of 20 litre/mn being passed over in the first 15 min. The mixture is heated at 63° C. for 6 h, then the temperature is increased to 95° C. in the course of one hour and kept at 95° C. for a further 2 h. After cooling, the polymer is washed with copious water over a 100 μm screen then dried at 80° C. 920 g of regular beads having a mean particle size of 460 μm are obtained. The silicon dioxide content is 5.1% by weight.

### Example 4

Preparation of a Silicon-Dioxide-Containing Polymer Bead

Example 3 is repeated, 75 g of silanized silicon dioxide from Example 2 being used. This produces 945 g of regular beads having a mean particle size of 490 μm and a silicon dioxide content of 7.35%.

1. A process for the preparation of a silicon-dioxide-containing polymer bead, wherein
I) a mixture of
a) styrene
b) crosslinker
c) finely divided surface-modified silicon dioxide and
d) free-radical initiator is produced, and
II) the resultant mixture is cured in aqueous phase at elevated temperature to give a polymer bead.

2. A process according to claim 1, wherein an inert agent is additionally added to the mixture at I).

3. A process according to claim 1, wherein the silicon dioxide is surface-modified using a silane compound.

4. A silicon-dioxide-containing polymer bead obtained by
I) mixing
a) styrene
b) crosslinker
c) finely divided surface-modified silicon dioxide and
d) free-radical initiator and
II) curing the resultant mixture in aqueous phase at elevated temperature to give a polymer bead.

5. A silicon-dioxide-containing polymer bead according to claim 4, wherein an inert agent is additionally added to the mixture at I).

6. A silicon-dioxide-containing polymer bead according to claim 4, wherein the silicon dioxide is surface-modified using a silane compound.

7. A method for preparing ion exchangers, chelating resins, chromatography resins, catalysts or adsorber resins which comprises preparing same with the silicon-dioxide-containing polymer bead of claim 4.
